(19) United States
(12) Patent Application Publication
(10) Pub. No.: US 2024/0342810 A1
(43) Pub. Date: Oct. 17, 2024

(54) ASSEMBLY FOR MACHINING WORKPIECES

(71) Applicant: P&L GmbH & Co. KG, Soltau (DE)

(72) Inventor: Jürgen RÖDERS, Soltau (DE)

(73) Assignee: P&L GmbH & Co. KG, Soltau (DE)

(21) Appl. No.: 18/751,637

(22) Filed: Jun. 24, 2024

Related U.S. Application Data
(63) Continuation of application No. PCT/EP2023/052497, filed on Feb. 2, 2023.

(30) Foreign Application Priority Data
Feb. 3, 2022 (DE) 102022102551.9

(51) Int. Cl. B23C 5/00; B23C 5/26; B23C 9/00

(52) U.S. Cl. CPC B23C 5/006; B23C 5/26; B23C 9/00; B23C 2210/02; B23C 2210/084

(57) ABSTRACT

An arrangement for machining workpieces includes a machining tool (1) having a cutting edge region (3) and a shank (30), the shank (30) having a conical shank region (5) and a receiving region (4) arranged adjacent to the shank region (5), a tool extension (2) having a conical receiving region (21), the conical shank region (5) and the conical receiving region (21) being designed complementary to each other such that the machining tool (1) is held between the conical shank region (5) and the conical receiving region (21) exclusively by means of a force-fitting connection in the tool extension (2), a tool holding device (15) for receiving the tool extension (2). The tool holding device (15) is adapted to be connected to a rotatable spindle of a machine tool. The cutting edge region (3) has a maximum diameter D1 in a plane E perpendicular to a center axis X.

### CROSS-REFERENCE TO RELATED APPLICATIONS

This application is a continuation of PCT/EP2023/052497 filed on Feb. 2, 2023 which claims priority to DE102022102551.9 filed on Feb. 3, 2022, the entire contents of which are herein incorporated by reference.

### BACKGROUND

The invention relates to an arrangement for machining workpieces using a machining tool and a tool holding device, for example for use with a metal-cutting machine such as a milling machine or a drilling machine.

For a milling or grinding operation or the like, machining tools are usually clamped into tool holding devices. At one end, the tool holding devices are adapted for clamping the machining tools with a clamping means suitable for this purpose.

Usually, the machining tools to be clamped have a cylindrical shank at the end provided for clamping them in the tool holding device. This shank may be clamped using various clamping methods, wherein a collet chuck is very common, in which an elastic collet is compressed with a nut so that the shank of the machining tool is firmly clamped in the tool holding device. Another method for clamping tools in tool holding devices is thermal shrinking, wherein a fitting bore of the tool holding device at the end where the machining tool is to be clamped is very precisely matched to the fit of the cylindrical shank of the machining tool. The fitting hole in the tool holding device will be widened by heating to such an extent that the shank of the machining tool may be inserted. When the tool holding device subsequently cools down again, the fitting hole in the tool holding device becomes smaller, thus clamping the shank of the tool. To release the machining tool, the tool holding device with the machining tool clamped therein is re-heated until the machining tool can be removed. Herein, in particular, the heating required is disadvantageous and it is also disadvantageous that an outer diameter of the tool holding device is much larger than a diameter of the shank of the tool to be clamped, in particular when collets are used. As shown in FIG. 10, the large difference in diameter between a tool holding device 103 and the shank of the machining tool 102 is unfavorable during many machining situations. If, as shown in FIG. 10, workpieces having relatively steep walls or narrow slots or the like are to be machined, collisions may occur between the tool holding device 103 and the workpiece 101. The steep wall of the workpiece 101 can only be machined in the upper region by the machining tool 102. Machining in the lower region of the steep wall would result in collision between the tool holding device 103 and the workpiece 101 at the location K.

Such a collision could be avoided by selecting a longer machining tool 102 and allowing it to project further from the tool holding device 103. However, this has the disadvantage that, on the one hand, the machining tool 102 becomes more expensive and, in particular, the machining procedure becomes unstable and much more susceptible to vibrations due to the long length of the machining tool 102. This leads to greater inaccuracies and/or poor surface qualities.

Another circle of issues with clamping machining tools in tool holding devices, especially when high rotational speeds are applied, is that long machining tools are more at risk of tool breakage. Furthermore, tool holding devices are usually made of steel. If the tool holding device is kept very long and slim, e.g. in order to be able to keep the machining tool to be clamped shorter, there is a risk at high rotational speeds that the tool holding device will bend so that it finally breaks off to hit housing parts of the machine in the working region with great force and may even penetrates them, thereby endangering operators in the vicinity of the machine tool.

### SUMMARY

It is therefore the object of the present invention to provide an arrangement for machining workpieces and a machine tool having simple design and simple, inexpensive manufacturability, which, on the one hand, provides safe clamping of the machining tool and, on the other hand, also enables machining of steep surfaces on wall regions of workpieces or grooves or deep bores or the like which are difficult to machine. Furthermore, safety in the environment of a machine tool is to be improved by the arrangement according to the invention.

This object will be achieved by providing an arrangement having the features of claim 1 and a machine tool having the features of claim 15. The subclaims show preferred further embodiments of the invention.

By contrast, the arrangement according to the invention for machining workpieces having the features of claim 1 has the advantage that the disadvantages described above may be overcome. In particular, secure fixing of a machining tool to a tool holding device, for example a collet chuck holder, may be realized. This also avoids the length of the tool holding device to protrude, as previously described, which is hazardous to operators. At the same time, it is possible to work with a short and thus cost-effective machining tool, so that the machining tool does not unnecessarily protrude far from a tool holding device in the axial direction of the machining tool. Nevertheless, the arrangement can be made very slim and narrow, so that safe machining of deep grooves or deep bores or the like is also possible without difficulty. According to the invention, this will be achieved in that the arrangement for machining workpieces comprises a machining tool with a cutting edge region and a shank. The shank comprises a conical shank region and a holding region arranged between the cutting edge region and the conical shank region for gripping the machining tool. Thus, a machining tool can be gripped at the holding portion. The holding region is preferably cylindrical, but may also be groove-shaped or the like, for example. The arrangement further comprises a tool extension having a receiving opening for receiving the machining tool. The receiving opening has a conical receiving region for the conical shank region of the machining tool. The conical shank region and the conical receiving region are designed complementary to each other with the same cone angle such that, between the conical shank region and the conical receiving region, the machining tool is held in the tool extension exclusively by means of a force-fitting connection. Thus, with the arrangement according to the invention, no shrinking process or the like has to be carried out in order to hold the machining tool in the tool extension.

Furthermore, the arrangement for machining workpieces comprises a tool holding device for receiving the tool extension, the tool holding device being adapted to be connected to a rotatable spindle of a machine tool or the like. The cutting edge region of the machining tool has a maximum diameter D1 in a plane E perpendicular to a center axis of the machining tool. In this case, the plane E intersects a bounding volume, which is a mathematical extension of an outer cone of the tool extension, such that a maximum first distance A1 of the bounding volume from the cutting edge region is at most 10% of the diameter D1 of the cutting edge region. Alternatively, the bounding volume contacts the cutting edge region. Thus, the bounding volume, which is a truncated cone, tangentially abuts the cutting edge region when the cutting edge region is preferably a sphere or partial sphere. Further alternatively, the bounding volume penetrates the cutting edge region. In this case, the bounding volume penetrates the cutting edge region in the plane E such that a maximum second distance A2 in the plane E of the cutting edge region to the bounding volume is less than or equal to 30% of the maximum diameter D1 of the cutting edge region.

Preferably, the bounding volume penetrates the cutting edge region such that the maximum second distance A2 in the plane E of the cutting edge region to the bounding volume is less than or equal to 20%, in particular less than or equal to 10%, of the maximum diameter D1 of the cutting edge region.

Furthermore, the outer cone of the tool extension has a first cone angle a, which is smaller than or equal to 10°, preferably smaller than 8°, more preferably smaller than 5°. Furthermore, even in the assembled state, a distance A of a free end of the cutting edge region to an exposed end of the tool extension is less than 5 times as large as the maximum diameter D1 of the cutting edge region, preferably less than 3 times, more preferably less than 2 times as large as the diameter D1.

Thus, according to the invention, a short machining tool can securely be clamped and surfaces on a workpiece that are difficult to machine may be reached for machining.

Thus, by combining features according to the invention, the present invention provides for simple and safe clamping of the machining tool into the tool extension, which tool extension in turn can then be clamped in a tool holding device in a simple and safe manner.

Further preferably, the end of the tool extension opposite the conical receiving region is cylindrical, so that this can be clamped in a tool holding device, e.g. a collet holder or shrink fit holder, in a well-established manner.

Preferably, the conical shank region is designed as an outer cone with a second cone angle b, and the conical receiving region is designed as an inner cone with a third cone angle c. This enables simple and inexpensive as well as robust design of the arrangement. Preferably, an outer diameter D2 of the exposed end of the tool extension is at most 20%, in particular at most 10%, larger than the diameter D1 of the cutting edge region.

Alternatively, the conical shank region is formed as an inner cone with a second cone angle b and the conical receiving region is formed as an outer cone with a third cone angle c. Thus, a conical cone is formed on the receiving region and a conical receptacle is formed on the machining tool. Preferably, an outer diameter D4 of an exposed end of the machining tool is at most 20% larger than the diameter D1 of the cutting edge region.

Preferably, a wall strength of the component including the inner cone, i.e., the tool extension or the machining tool, is in a range of 0.2 mm to 1.0 mm, in particular 0.3 mm to 0.8 mm at the exposed end.

Preferably, only the tool extension is made of a hard metal material, or further preferably, the machining tool and the tool extension are each made of a hard metal material, and are preferably made of the same hard metal material.

The use of hard metal material for the machining tool and the tool extension ensures that even in the event of breakage of the machining tool or the tool extension, no bending or at most minimal bending of the machining tool or tool extension occurs, so that in the event of tool breakage, significantly lower forces act on the broken-off part of the machining tool or tool extension compared with long tool holding devices or tool extensions made of steel. This minimizes the risk of penetrating the housing components of a machine tool or the like. This significantly reduces the risk of injury to operators in the immediate vicinity of the machine tool. Another preferred feature is that the tool holding device is also made of hard metal material. Particularly preferred, the machining tool, the tool extension and the tool holding device are made of hard metal material.

Preferably, the first cone angle a is greater than or equal to the second and third cone angles b, c of the conical shank region and the conical receiving region.

Preferably, the second cone angle b of the conical shank region and the third cone angle c of the conical receiving region is in a range of 1.5° to 4°, preferably 2° to 3°.

According to another preferred embodiment of the present invention, the conical shank region has a clamping region that has a length L that is 1.5 times the diameter D1 of the cutting edge region. This provides secure retention of the machining tool in the tool extension.

Preferably, the machining tool also comprises a circumferential collar which is arranged between the conical shank region and the holding region and projects radially outward. On the one hand, the collar serves as a closure of the conical shank region and, on the other hand, the collar prevents a gripping tool from reaching into the conical shank region and damaging it, for example, when the machining tool is gripping the holding region. The collar thus ensures secure pressing of the machining tool into the tool extension.

Furthermore it is preferred for an axial press-fit path, which is in the range of complete contact between the conical shank region and the conical holding region and force-fitting connection between the conical shank region and the conical holding region, to be less than or equal to 8%, in particular less than or equal to 6%, of the maximum diameter D1 of the cutting edge region.

Further preferably, the arrangement comprises a control unit, which is arranged to move a gripper, which grips the machining tool at the holding region, in a path-controlled manner as a function of the press-fit path between the conical shank region and the conical receiving region for creating the force-fitting connection between the conical shank region and the conical receiving region. Thus, the control unit predetermines a measure for the press-fit path between the conical shank region and the conical receiving region to create the force-fitting connection between them.

Preferably, when press-fitting the machining tool into the tool extension in a path-controlled manner, selection of the press-fit path is performed as a function of a maximum diameter of the conical receiving region and/or a cone angle of the conical receiving region.

Further preferably, the control unit is arranged to move the gripper, which grips the machining tool at the holding region, in a force-controlled manner as a function of a press-fit force between the conical shank region and the conical receiving region to create the force-fitting connection between the tool extension and the machining tool. The control unit thus sets a press-fit force used to create the force-fitting connection between the conical shank region and the conical receiving region.

Preferably, during force-fittingly pressing the machining tool into the tool extension, the maximum press-fit force is selected as a function of a maximum diameter of the conical receiving region and/or a cone angle of the conical receiving region.

Preferably, when press-fitting is performed in a force-fitting manner, it will be path- and force-controlled, for example by monitoring the press-fit force during path-controlled press-fitting, and suspending the path-controlled press-fit when a maximum press-fit force is exceeded.

Preferably, the arrangement further comprises a plunger and the tool extension and the tool holding device each comprise a through hole, the plunger being insertable through the through holes to release the force-fitting connection between the machining tool and the tool extension and eject the machining tool.

Furthermore, the present invention relates to a machine tool, in particular a milling machine or a grinding machine or a drilling machine having the arrangement according to the invention for machining workpieces. The machine tool preferably comprises a separate device, for example a robot, for automatic replacing a machining tool into a tool extension, wherein the machining tool is preferably force-fittingly inserted into the tool extension under path control and/or force control using a control unit.

Further preferably, the machine tool is a high speed machine tool in a range of 10,000 rpm to 100,000 rpm.

Thus, the present invention is able to solve a problem that has been present in prior art for a long time, in a surprisingly simple manner by providing conical force-fitting connection between the machining tool and the tool extension, wherein the machining tool and the tool extension may preferably be made of hard metal, preferably of the same hard metal. The invention is of particular advantage when using small machining tools having a small maximum diameter D1 at the cutting edge region, preferably D1 is smaller than 3 mm, and smaller axial length, preferably a maximum of 5×D1. Preferably, the arrangement according to the invention is used in machine tools for finishing operations wherein only small forces occur.

### BRIEF DESCRIPTION OF THE DRAWINGS

In the following, preferred examples embodiments of the invention will be described in detail while reference will be made to the accompanying drawing, wherein:

FIG. 1 is a schematic sectional view of an arrangement for machining workpieces according to a first example embodiment of the invention, wherein a machining tool is force-fittingly arranged in a tool extension,

FIG. 2 is a schematic lateral view of the machining tool of FIG. 1,

FIG. 3 is a schematic sectional view of a portion of the tool extension of FIG. 1,

FIG. 4 is a schematic, enlarged view of FIG. 1,

FIG. 5 is a schematic sectional view of an arrangement for machining workpieces according to a second example embodiment, in which the machining tool is force-fittingly fixed in the tool extension,

FIG. 6 is a schematic sectional view of an arrangement for machining workpieces according to a third example embodiment, in which the machining tool is force-fittingly fixed in the tool extension,

FIG. 7 is a schematic sectional view of an arrangement for machining workpieces according to a fourth example embodiment of the invention, wherein a machining tool is force-fittingly arranged in a tool extension,

FIG. 8 is a schematic, partially sectional view of the machining tool of FIG. 7,

FIG. 9 is a schematic sectional view of the tool extension of FIG. 7, and

FIG. 10 is a schematic view of a prior art workpiece machining arrangement.

### DETAILED DESCRIPTION

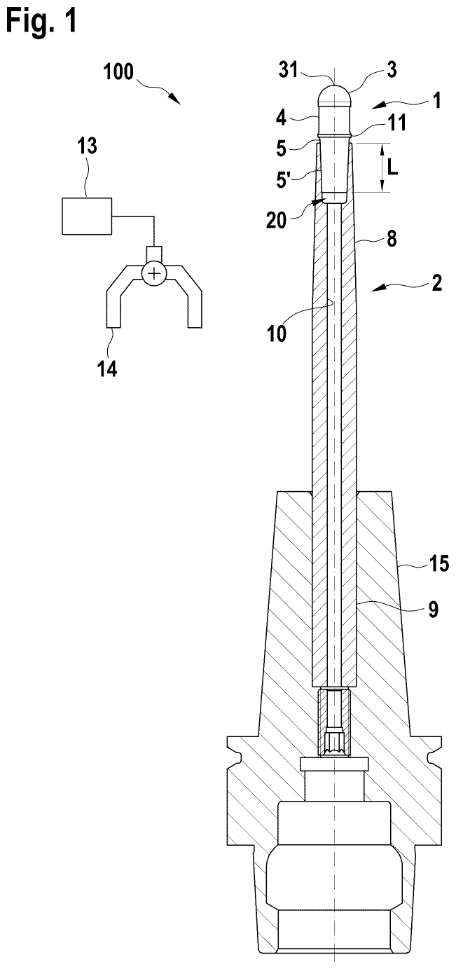

In the following, an arrangement 100 for machining workpieces according to a preferred example embodiment of the invention is described in detail, while reference is made to FIGS. 1 to 4.

As may be seen from FIG. 1, the arrangement 100 for machining workpieces comprises a machining tool 1, a tool extension 2 and a tool holding device 15. FIG. 1 shows the assembled state of the machining tool 1 in the tool extension 2.

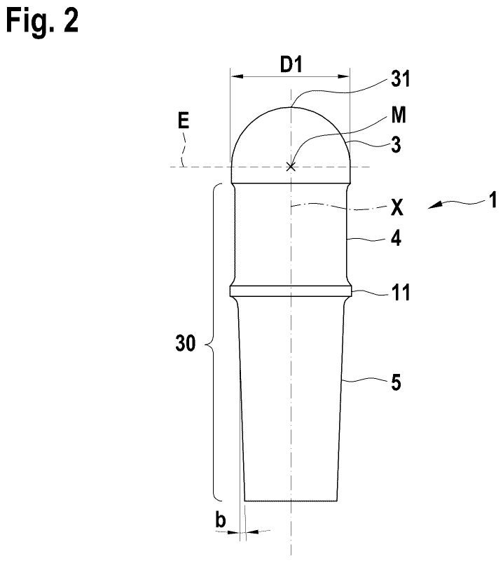

In FIG. 2, the machining tool 1 is shown in detail. The machining tool 1 comprises a cutting edge region 3 and a shank 30. The shank 30 is formed with a conical shank region 5 and a holding region 4 arranged between the cutting edge region 3 and the shank region 5. The holding region 4 serves as a region for gripping the machining tool 1, for example by means of a gripper 14, when it is inserted into and removed from the tool extension 2.

In this example embodiment, the holding region 4 is cylindrical. Furthermore, a collar 11 is located between the holding region 4 and the conical shank region 5, which collar projects radially outwardly from the lateral surface of the shank 30. The collar 11 is formed completely circumferentially.

The tool extension 2 has a first cone angle a at an outer cone 8, as well as a cylindrical portion 9 which adjoins the outer cone 8.

The conical shank region 5 has a second cone angle b. In this example embodiment, the second cone angle b is 2°.

In this example embodiment, the cutting edge region 3 of the machining tool 1 is spherical having a center M and a maximum diameter D1 in a plane E that is perpendicular to a center axis X of the machining tool 1. In this case, the machining tool 1 is made of a hard metal material.

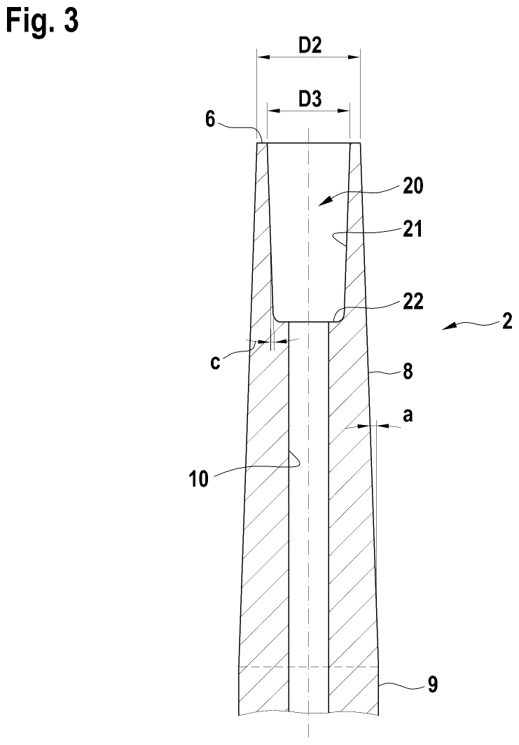

A portion of the tool extension 2 is shown in detail in FIG. 3. The tool extension 2 has a receiving opening 20, which is continuously formed through the tool extension in this example embodiment. The receiving opening 20 comprises a cylindrical bore 10 and a conical receiving region 21. A shoulder 22 is provided between the conical receiving region 21 and the bore 10.

The conical receiving region 21 has a third cone angle c, which is also 2°. Thus, the conical shank region 5 and the conical receiving region 21 are provided complementary to each other with the cone angles b, c being equal.

The tool extension 2 further comprises the outer cone 8 with the first cone angle a. The first cone angle a is larger than the second and third cone angles b, c and is 3° in this example embodiment.

In this regard, the tool extension 2 has an outer diameter D2 and an inner diameter D3 at an exposed end 6 of the tool extension 2. Preferably, the outer diameter D2 is at most 40%, preferably at most 30% larger than the inner diameter D3. Further preferably, the outer diameter D2 is as well at most 20%, in particular 10%, larger than the maximum diameter D1 of the cutting edge region 3.

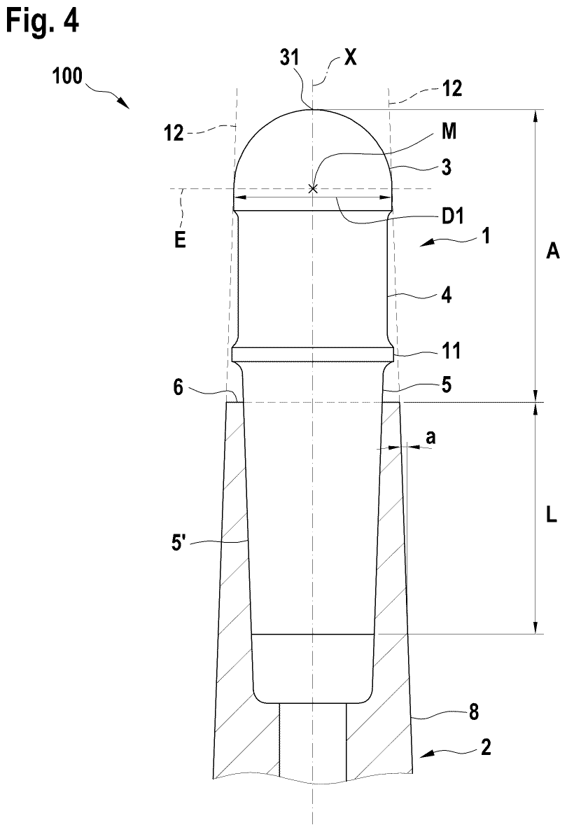

As may be seen from FIGS. 1 and 4, between the conical shank region 5 and the conical receiving region 21, the machining tool 1 is held in the tool extension 2 exclusively by force-fitting connection. This results in a clamping region 5′ having an axial length L between the two conical surfaces (cf. FIG. 4). The clamping region 5′ is slightly shorter than the entire conical shank region 5, so that a small portion of the conical shank region 5 protrudes from the tool extension 2 (see FIG. 1).

As may be seen in detail from FIG. 4, the maximum diameter D1 of the cutting edge region 3 is selected such that a bounding volume 12, which is a mathematical extension of the outer cone 8 of the tool extension 2, tangentially abuts the plane E at the maximum diameter D1.

The bounding volume 12 thus mathematically forms a truncated cone by virtue of the first cone angle a at the outer cone 8 of the tool extension 2, in which the cutting edge region 3 tangentially abuts at its maximum diameter D1 in the plane E.

Furthermore, in the assembled state of the machining tool 1 in the tool extension 2, a distance A of a free end 31 of the cutting edge region 3 to the exposed end 6 of the tool extension 2 is less than 5 times the maximum diameter D1 of the cutting edge region 3. In this example embodiment, the distance A is twice the maximum diameter D1 (A=2×D1).

The tool extension 2 is also made of a hard metal material. It should be noted that the same hard metal as for the machining tool 1 may be used herein, or another hard metal will be used alternatively. Importantly, the tool extension 2 in particular is made of hard metal, since the tool extension is longer than the short machining tool 1, which may also be made of steel.

In particular, this prevents deformation of the machining tool 1 and/or displacement of the tool extension 2 from the center axis X during operation, especially at high rotational speeds.

Thus, breakage of the machining tool 1, which can never be avoided by 100% during operation of a machine tool, is significantly less hazardous compared to prior art, in which tool extensions made of steel or very long tool holding devices made of steel are used. In the case of steel materials for the machining tool 1 and/or the tool extension 2, bending of these components may occur at very high rotational speeds, so that, in the event of tool breakage, an additional momentum then acts on the broken-off tool portion, the momentum depending on the degree of bending (lever arm). As a result, the broken-off tool portion made of steel acts like a projectile and may also penetrate through protective means such as a hood or disk of a machine tool or the like.

Insertion of the machining tool 1 into the receiving opening 20 of the tool extension 2 may be carried out in various ways to create the force-fitting connection between the machining tool 1 and the tool extension 2. Preferably, a control unit 13 is provided, which is arranged to move the gripper 14, which grips the machining tool 1 at the holding region 4, in a path-controlled manner as a function of the press-fit path between the conical shank region 5 and the conical receiving region 21 to create the force-fitting connection. Thus, the control unit 13 specifies a length of the press-fit path by which the machining tool 1 is moved into the tool extension 2 to establish the force-fitting connection.

Alternatively or additionally, the control unit 13 may be adapted to move the gripper 14 in a force-controlled manner as a function of a press-fit force between the conical shank region 5 and the conical receiving region 21 to produce the force-fitting connection. By presetting the press-fit force, it may be ensured that the machining tool 1 is securely held in the tool extension 2. Herein, the control unit may also predefine the combination, i.e. a value for the press-fit path and a value for the press-fit force, wherein it is also possible herein to specify respective ranges with lower and upper threshold values.

As may be seen from FIGS. 1 and 3, the tool extension 2 has a relatively small wall strength in a range from 0.2 mm to 1.0 mm at the exposed end 6. Thus, a very slim tool extension 2 is provided, so that machining of deep grooves, deep bores or long wall regions in the direction of the center axis X of the machining tool 1 is possible. This allows relatively short machining tools 1 to be used, so that the risk of tool breakage is significantly minimized compared with longer tools.

As indicated in FIG. 1, the tool holding device 15 can be attached to a spindle (not shown in FIG. 1) using any conventional clamping system.

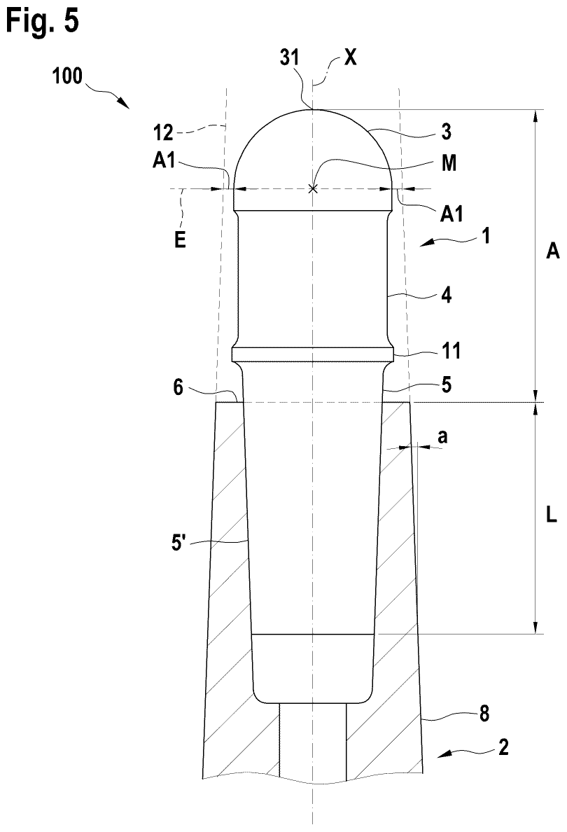

FIG. 5 shows an arrangement 100 according to a second example embodiment of the invention. Equal or functionally equal parts are designated with the same reference numbers as in the first example embodiment.

As may be seen from FIG. 5, in contrast to the first example embodiment, the dimensions between the bounding volume 12 and the maximum diameter D1 of the cutting edge region 3 are different in the second example embodiment. As shown in FIG. 5, the maximum diameter D1 of the cutting edge region 3 at the plane E is smaller than the diameter of the conical bounding volume 12 at the plane E. In this case, a first distance A1, which is designated at both sides of the cutting edge region 3 at the plane E, is provided. The first distance A1 is at most 10% of the diameter D1 of the cutting edge region. Otherwise, this example embodiment corresponds to the first example embodiment, and the same advantages will be obtained as in the first example embodiment, so that reference may be made to the description given therein.

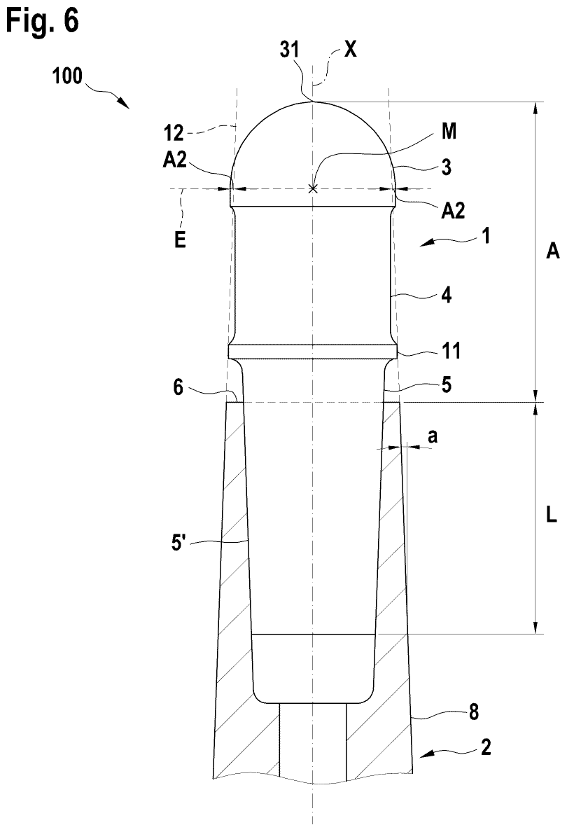

FIG. 6 shows an arrangement 100 for processing workpieces according to a third example embodiment of the invention. Equal or functionally equal parts are again designated with the same reference numbers as in the preceding example embodiment.

As may be seen from FIG. 6, in the third example embodiment, the bounding volume 12 is formed such that the bounding volume 12 intersects the cutting edge region 3. This results in a second distance A2 in the plane E between the conical bounding volume 12 and the maximum diameter D1 of the cutting edge region 3. The second distance A2 is present on both sides of the bounding volume to the sheath region of the cutting edge region 3. The second distance A2 is at most 30% of the maximum diameter D1 of the cutting edge region 3. Otherwise, this example embodiment corresponds to the preceding example embodiments, and the same advantages will be obtained as in the foregoing example embodiments, so that reference may be made to the description given therein.

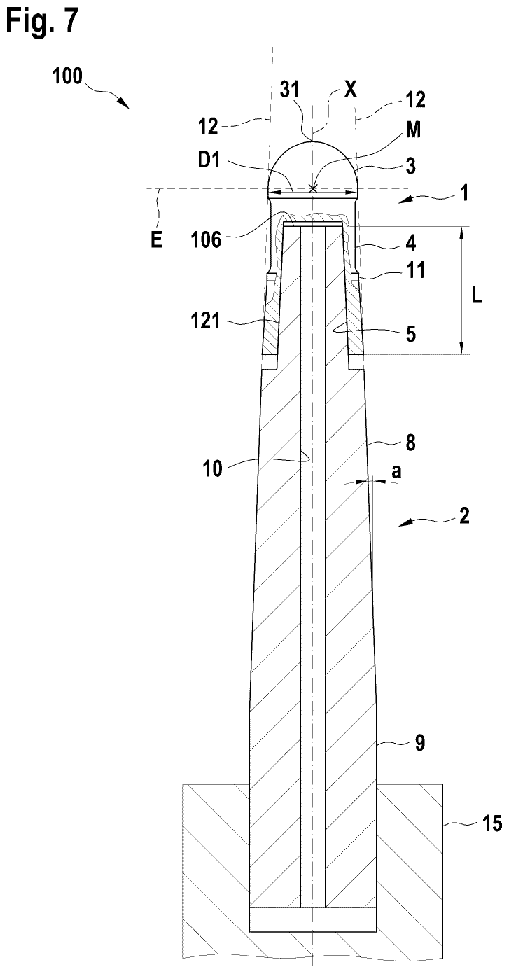

FIGS. 7 to 9 show an arrangement 100 for workpiece processing according to a fourth example embodiment of the invention. Equal or functionally equal parts are designated with the same reference numbers as in the first example embodiment.

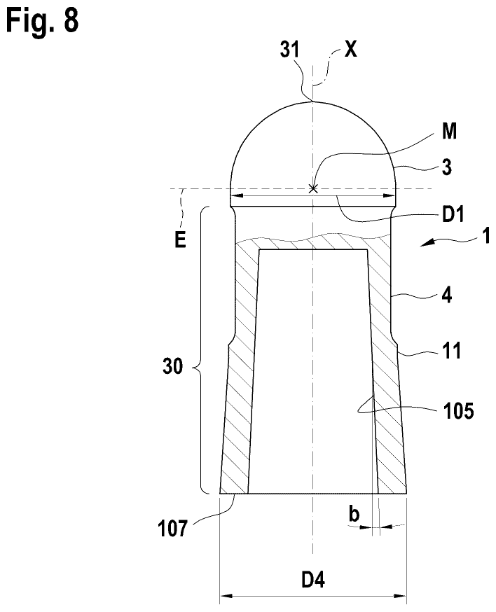

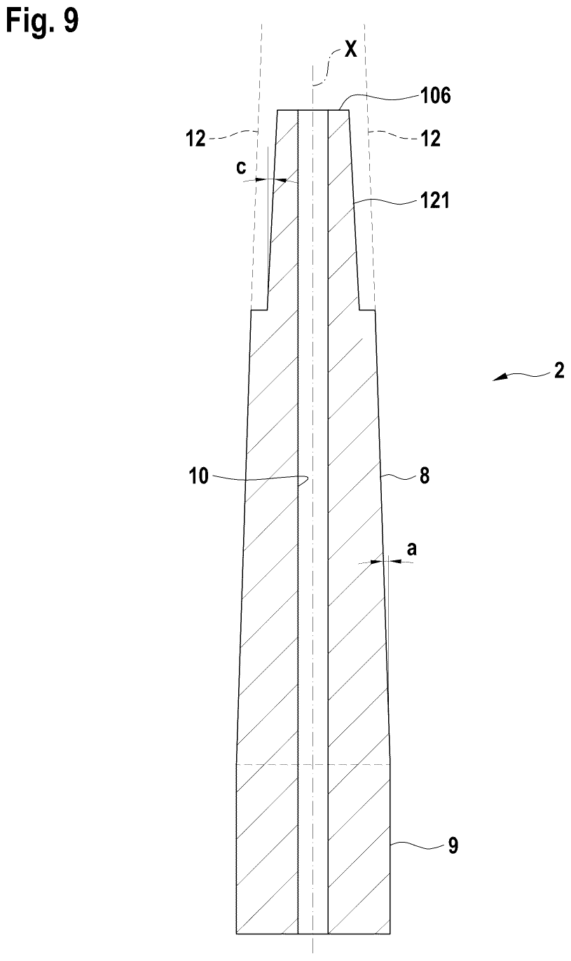

The fourth example embodiment is substantially the same as the first example embodiment, with the arrangement of the conical portion and the conical receptacle being interchanged between the machining tool 1 and the tool extension 2. That is, the machining tool 1, as the conical shank region, now has an inner cone with a second cone angle b as the conical receiving region 105, and the tool extension 2 has an outer cone with a third cone angle c as the conical receiving region 121 (cf. FIGS. 8 and 9). Between the conical receiving region 105 on the machining tool 1 and the conical receiving region 121 of the tool extension 2, a force-fitting connection is again exclusively formed, since the second and third cone angles b, c are again identically formed. An outer diameter D4 of an exposed end of the machining tool 1 is 10% larger than the diameter D1 of the cutting edge region 3.

In particular, this arrangement has the advantage that the machining tool 1 can be made even shorter, since the conical receiving region 105 allows an exposed end 106 of the tool extension 2 to be deeply inserted into the machining tool 1. Otherwise, this example embodiment corresponds to the preceding example embodiment, so that reference may be made to the description given therein.

With regard to all example embodiments, it should be noted that the invention was exemplified using a partially spherical machining tool 1, which has a partially spherical cutting edge region 3. However, it is also possible for the cutting edge region 3 to be cylindrical, toric or even conical, and in particular to taper towards the free end 31 of the cutting edge region 3. Other tool shapes may also be used in the invention, thereby obtaining the same advantages as for the machining tools 1 described in the example embodiments.

The arrangement for machining workpieces according to the invention is preferably used in conjunction with a machine tool, which may be a milling machine or grinding machine or drilling machine or the like.

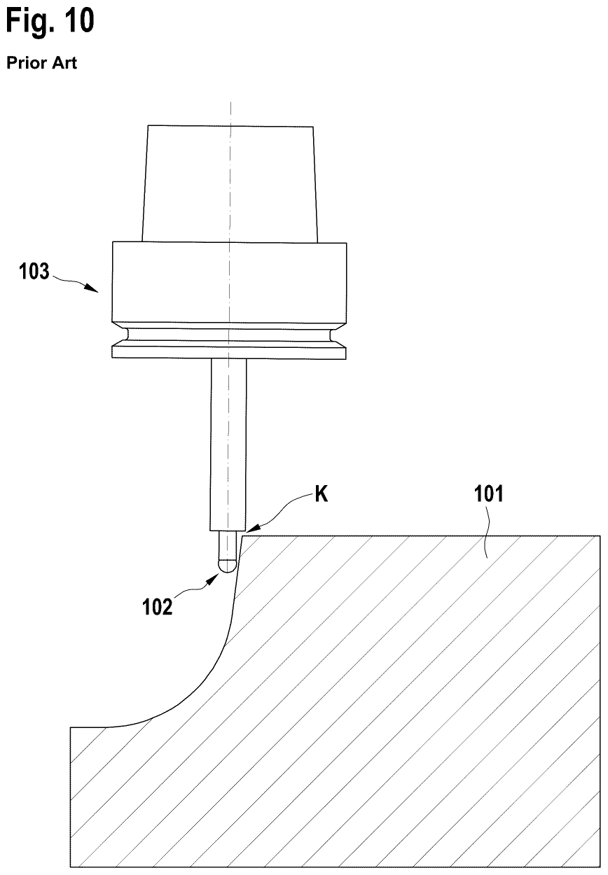

In addition to the foregoing written description of the invention, explicit reference is herewith made to the graphic representation of the invention in FIGS. 1 to 10 for additional disclosure thereof.

### LIST OF REFERENCE NUMBERS

1 Machining tool
2 Tool extension
3 Cutting edge region
4 Cylindrical holding region
5 Conical shank region
5′ Clamping region in assembled state
6 Exposed end of tool extension
8 Outer cone
9 Cylindrical portion of the tool extension
10 Bore
11 Collar
12 Bounding volume
13 Control unit
14 Gripper
15 Tool holding device
20 Tool receiving opening
21 Conical receiving region of the tool extension
22 Shoulder
30 Shank
31 Free end
100 Arrangement for machining workpiece
101 Workpiece
102 Machining tool
103 Tool holding device
105 Conical receiving region
106 Exposed end of tool extension
107 Exposed end of machining tool
121 Conical receiving region of tool extension
A Distance between exposed end 6 and free end 30
A1 First distance
A2 Second distance
D1 Diameter of cutting edge region
D2 Outside diameter of tool extension at exposed end
D3 Inner diameter of tool extension at exposed end
D4 Outside diameter of the machining tool at the exposed end
E Plane
K Collision location
L Clamping length of the clamping region
M Center point
X Center axis
a First cone angle/outer cone of the tool extension
b Second cone angle
C Third cone angle

1. An arrangement for machining workpieces, comprising
a machining tool (1) having a cutting edge region (3) and a shank (30), the shank (30) having a conical shank region (5) and a holding region (4) arranged adjacent to the shank region (5),
a tool extension (2) having a conical receiving region (21),
the conical shank region (5) and the conical receiving region (21) being complementary to each other such that the machining tool (1) is held between the conical shank region (5) and the conical receiving region (21) in the tool extension (2) exclusively by means of a force-fitting connection, and
a tool holding device (15) for receiving the tool extension (2), the tool holding device (15) being adapted to be connected to a rotatable spindle of a machine tool,
wherein the cutting edge region (3) has a maximum diameter D1 in a plane E perpendicular to a center axis X,
the plane E intersecting a bounding volume (12) which is a mathematical extension of an outer cone (8) of the tool extension (2), such that a maximum first distance A1 of the bounding volume (12) from the cutting edge region (3) is at most 10% of the diameter D1 of the cutting edge region (3) or the cutting edge region (3) touches the bounding volume (12) or the bounding volume (12) intersects the cutting edge region (3) such that a maximum second distance A2 in the plane E of the cutting edge region (3) is less than or equal to 30% of the diameter D1 of the cutting edge region (3),
wherein the outer cone (8) has a first cone angle a which is smaller than or equal to 10°, and
wherein a distance A of a free end (31) of the cutting edge region (3) to an exposed end (6) of the tool extension (2) is smaller than five times the maximum diameter D1 of the cutting edge region (3).

2. The arrangement according to claim 1,
wherein the conical shank region (5) is an outer cone having a second cone angle b, and the conical receiving region (21) is an inner cone having a third angle c.

3. The arrangement according to claim 2, wherein an outer diameter D2 of the exposed end (6) of the tool extension (2) is at most 20% larger than the diameter D1 of the cutting edge region (3), and/or
wherein the tool extension (2) has a wall strength in a range of 0.2 mm to 1.0 mm at the exposed end (6).

4. The arrangement according to claim 1,
wherein the conical shank region (105) is an inner cone having a second cone angle b on the machining tool (1), and the conical receiving region (121) is an outer cone having a third cone angle c on the tool extension (2).

5. The arrangement of claim 4, wherein an outer diameter D4 of an exposed end (107) of the machining tool is at most 20% larger than the diameter D1 of the cutting edge region (3).

6. The arrangement according to claim 1,
wherein the tool extension (2) is made of a hard metal material.

7. The arrangement according to claim 1,
wherein the first cone angle a of the outer cone (8) is greater than or equal to a second cone angle b of the conical shank region (5) and is greater than or equal to a third cone angle c of the conical receiving region (21).

8. The arrangement according to claim 1, wherein second and third cone angles b, c of the conical shank region (5) and the conical receiving region (21) are in a range of 1.5° to 4°.

9. The arrangement according to claim 1, wherein the conical shank region (5) comprises a clamping region (5′) having a length L which is 1.5 times the diameter D1 of the cutting edge region (3).

10. The arrangement according to claim 1, wherein the machining tool (1) further comprises a circumferential collar (11) between the conical shank region (5) and the holding region (4), which projects radially outwards.

11. The arrangement according to claim 1, wherein an axial press-fit path that is in a range between complete contact between the conical shank region (5) and the conical receiving region (21) and a force-fitting connection between the conical shank region (5) and the conical receiving region (21) is smaller than or equal to 8% of the diameter D1 of the cutting edge region (3).

12. The arrangement according to claim 11, further comprising a control unit (13), which is set up to move a gripper (14), which grips the machining tool (1) at the holding region (4) in a path-controlled manner as a function of the press-fit path between the conical shank region (5) and the conical receiving region (21) to create the force-fitting connection between the conical shank region (5) and the conical receiving region (21).

13. The arrangement according to claim 11, further comprising a control unit (13), which is adapted to move a gripper (14), which grips the machining tool (1) at the holding region (4), in a force-controlled manner as a function of a press-fit force between the conical shank region (5) and the conical receiving region (21) for producing the force-fitting connection between the conical shank region (5) and the conical receiving region (21).

14. The arrangement according to claim 1, wherein the tool extension (2) comprises an outer sheath having the outer cone (8) and a cylindrical portion (9).

15. A machine tool comprising an arrangement according to claim 1.
